(19) United States
(12) Patent Application Publication
(10) Pub. No.: US 2017/0353945 A1
(43) Pub. Date: Dec. 7, 2017

(54) TRANSMISSION OF EXCESS DATA OF A MULTICAST SERVICE ON ANOTHER RADIO COMMUNICATION RESOURCE

(71) Applicant: Nokia Solutions and Networks Oy, Espoo (FI)

(72) Inventors: David Navratil, Helsinki (FI); Henri Markus Koskinen, Espoo (FI); Xiang Xu, Nanjing (CN)

(21) Appl. No.: 15/541,814

(22) PCT Filed: Jan. 7, 2015
(86) PCT No.: PCT/EP2015/050124

§ 371 Date: Jul. 6, 2017

(51) Int. Cl. H04W 72/00; H04L 12/18; H04W 72/04; H04W 48/10

(52) U.S. Cl. CPC H04W 72/005; H04W 72/0446; H04L 12/1881; H04W 48/10

(57) ABSTRACT

A method of transmission of excess data associated with a multicast service is scheduled on another radio communication resource. The multicast service may be MBMS or push-to-talk. The method includes determining, at the eNodeB base station, that an amount of data to be multicast during an upcoming scheduling period exceeds the associated multicast communication resource, and accordingly temporarily allocate additional resources on another multicast service communication resource, or else on resources dedicated to conventional services, or else on both kind of resources simultaneously. The base station transmits an indication to the UE(s) about the additional allocation(s) by using MCH scheduling information, such signaling comprising a logical channel identification, LCID, field.

### TECHNICAL FIELD

This description relates to wireless networks.

### BACKGROUND

Data in a wireless network may be multicast from a network node, such as a base station, to other nodes, such as user devices. Communication resources dedicated to multicasting the data may at times be insufficient to multicast the data.

### SUMMARY

According to an example embodiment, a method may include determining, by a base station, that data to be multicast during a scheduling period exceeds a dedicated multicast communication resource, and multicasting the data via the dedicated multicast communication resource and at least one other communication resource comprising at least one of a multicast communication resource dedicated to other data and a communication resource not dedicated to multicast.

According to another example embodiment, a non-transitory computer-readable storage medium comprising instructions for transmitting multicast data via a communication resources not dedicated to that multicast data stored thereon. When executed by at least one processor, the instructions may be configured to cause a base station to determine that data to be multicast during a scheduling period exceeds a dedicated multicast communication resource, and multicast the data via the dedicated multicast communication resource and at least one other communication resource comprising at least one of a multicast communication resource dedicated to other data and a communication resource not dedicated to multicast.

According to another example embodiment, a base station may include at least one processor, and at least one non-transitory computer-readable storage medium comprising instructions for processing multicast data received within at least one multicast packet and at least one unicast packet stored thereon. When executed by the at least one processor, the instructions may be configured to cause the base station to determine that data to be multicast during a scheduling period exceeds a dedicated multicast communication resource, and multicast the data via the dedicated multicast communication resource and at least one other communication resource comprising at least one of a multicast communication resource dedicated to other data and a communication resource not dedicated to multicast.

According to another example embodiment, a method may include receiving, by a user device, an indication that multicast data will be transmitted also via at least one other communication resource comprising at least one of a multicast communication resource dedicated to other data and a communication resource not dedicated to multicast, and receiving at least in part the multicast data on the indicated resources.

According to another example embodiment, a non-transitory computer-readable storage medium may include instructions for processing multicast data received within at least one multicast packet and at least one unicast packet stored thereon. When executed by at least one processor, the instructions may be configured to cause a user device to receive an indication that multicast data will be transmitted also via at least one other communication resource comprising at least one of a multicast communication resource dedicated to other data and a communication resource not dedicated to multicast, and receive at least in part the multicast data on the indicated resources.

According to another example embodiment, a user device may include at least one processor, and at least one non-transitory computer-readable storage medium comprising instructions for processing multicast data received within at least one multicast packet and at least one unicast packet stored thereon. When executed by the at least one processor, the instructions may be configured to cause the user device to receive an indication that multicast data will be transmitted also via at least one other communication resource comprising at least one of a multicast communication resource dedicated to other data and a communication resource not dedicated to multicast, and receive at least in part the multicast data on the indicated resources.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram of a network according to an example embodiment.

FIG. 2A is a diagram of a scheduling period according to an example embodiment.

FIG. 2B is another diagram of the scheduling period according to an example embodiment.

FIG. 3 is a diagram showing three scheduling periods according to an example embodiment.

FIG. 4A is a diagram of a scheduling information element according to an example embodiment.

FIG. 4B is a diagram of another scheduling information element according to an example embodiment.

FIG. 5 shows a method performed by the base station according to an example embodiment.

FIG. 6 shows a method performed by a user device according to an example embodiment.

FIG. 7 is a block diagram of a wireless station according to an example embodiment.

Like references refer to like elements.

### DETAILED DESCRIPTION

In wireless networks, such as a Long-Term Evolution (LTE) or LTE-Advanced network, a base station may allocate communication resources for communication to and from multiple nodes such as user devices. The resources may be allocated in a single frequency network (such as a Multimedia Broadcast multicast service Single Frequency Network (MBSFN)) by a multicell coordination entity (MCE). The MCE may take five seconds or more to update the allocation, which may be too long to support services with variable bit rates and/or variable data rate requirements. Variable bit rate services and/or variable data rate services that are broadcast and/or multicast to nodes such as user devices, such as push-to-talk which may include public safety communications, may benefit from dynamic resource management to efficiently serve variable bit rate services and/or variable data rate services.

Multiple services may be multiplexed on a single physical multicast channel (PHCH). The base station may allocate multicast communication resources using statistical multiplexing techniques, by which the dedicated multicast communication resource allocated to the PMCH are less than a sum of an aggregated bit rate of multiplexed Multimedia Broadcast Multicast Services (MBMSs). At times, the dedicated multicast communication resource may be insufficient to send all of the data for the multiplexed multicast services. To send all of the data for the multiplexed multicast services without dropping any packets, the base station may multicast the data via the dedicated multicast communication resource and at least one other communication resource. The other communication resource may include another PMCH, and/or a communication resource not dedicated to multicast such as an on-demand channel and/or unicast channel. The on-demand channel and/or unicast channel may include an on-demand subframe and/or an on-demand unicast subframe.

The base station may, for example, determine that data to be multicast during a scheduling period exceeds the dedicated multicast communication resource. The dedicated multicast communication resource may include, for example, a specific PMCH (such as one or more identified subframes). Based on determining that the data to be multicast exceeds the dedicated multicast communication resource, the base station may multicast the data via the dedicated multicast communication resource and the at least one other communication resource. In one embodiment, the other communication resource may include another PMCH for multicasting data of the specific PMCH. That is, the base station may apply unused subframes from another PMCH in the same MBSFN area to transmit multicast data of the specific PMCH. In another embodiment, which may be used either instead of or in addition to the use of the subframes of another PMCH, the base station may temporarily borrow at least one subframe from a pool of unicast subframes at least partly constituting the other communication resource. The base station may apply the borrowed subframe for the transmission of the multicast data.

The other communication resource may include at least one subframe that is subsequent to the dedicated multicast communication resource, and/or the other communication resource may include one or more subframes that are interleaved with one or more subframes of the dedicated multicast communication resource.

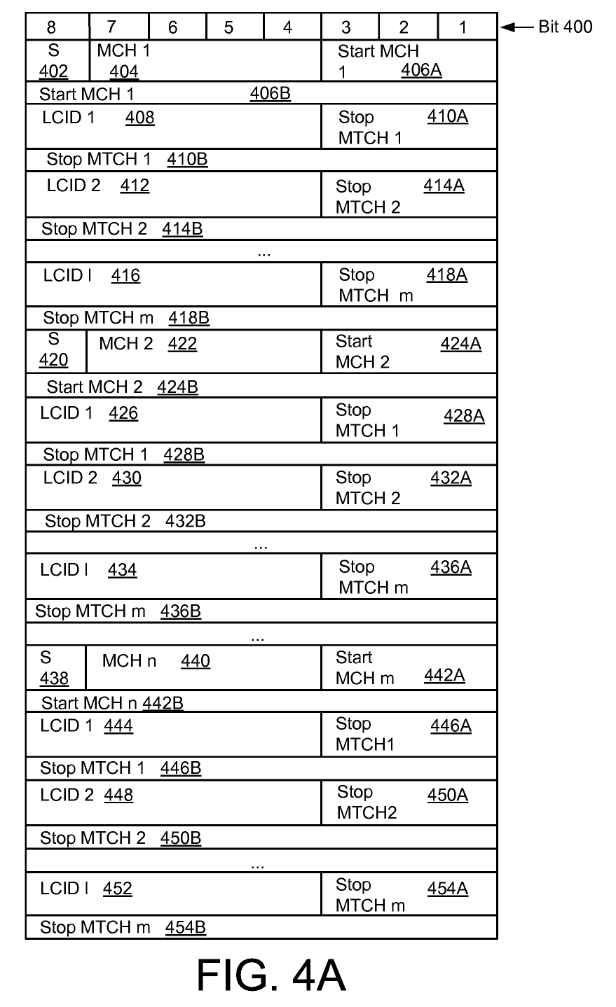

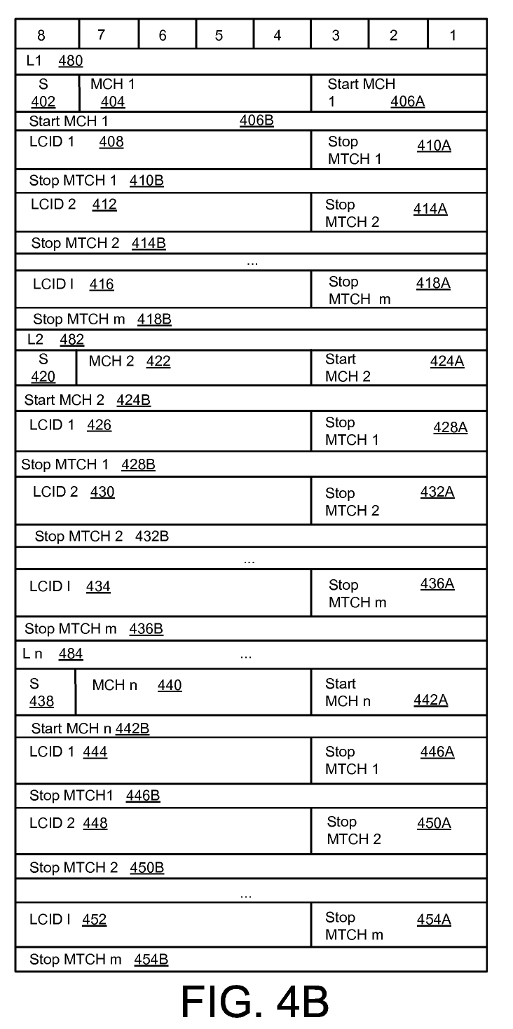

The base station may transmit an indication to the UEs about the additional allocation(s) by using control signalling sent on MCH. This new MCH scheduling information may be sent in the same subframe where the legacy MCH Scheduling Information is sent. However, in another embodiment, the new MCH scheduling information element is sent in another subframe than the legacy MCH Scheduling Information. A logical channel identification (LCID) field may be included in a multicast channel (MCH) medium access control (MAC) header and indicate existence of this new scheduling information control element, such as a scheduling information element shown in FIG. 4A or 4B, in the same MAC protocol data unit (PDU).

Further, in one embodiment, the base station may, for example, transmit also an indication of an allocated pool of sub frames at least partly constituting the other communication resource. The indication may be included in system information broadcast in a communication resource not dedicated to multicast, or on a multicast control channel (MCCH) of the dedicated multicast communication resource.

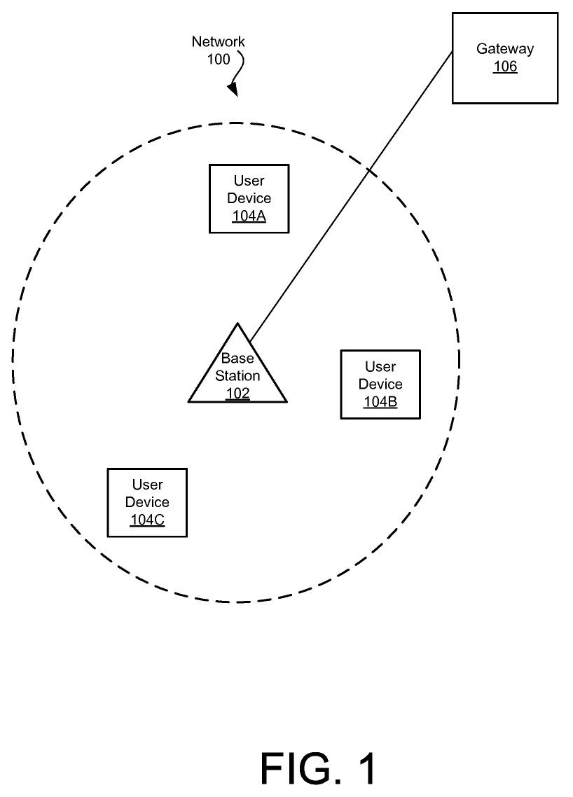

FIG. 1 is a diagram of a network 100 according to an example embodiment. The network 100 may include a wireless network, such as a wireless infrastructure network. The network 100 may include a wireless infrastructure network in which a base station 102 communicates with, and assigns communication resources to, multiple user devices 104A, 104B, 104C. The network 100 may include a cellular network, such as a fifth generation wireless mobile system (5G) network or a Long-Term Evolution (LTE) or LTE-Advanced network. While three user devices 104A, 104B, 104C are shown in FIG. 1, any number of user devices 104A, 104B, 104C may be included in the network 100. The base station 102 may forward data between the user devices 104A, 104B, 104C and a User-plane Gateway 106, base station controller, mobile switching center, gateway, and/or other upstream nodes in a packet network.

The user devices 104A, 104B, 104C may generate and send data in an uplink direction to the base station 102 in a form of packets (e.g., packets or frames) using uplink data communication resources and/or uplink wireless resources that the base station 102 assigned to and/or scheduled for the respective user device 104A, 104B, 104C. The base station 102 may also send data in a downlink direction to the user devices 104A, 104B, 104C. The base station 102 may broadcast data to all of the user devices 104A, 104B, 104C, may multicast data to a subset or group of the user devices 104A, 104B, 104C, and/or may unicast data to one of the user devices 104A, 104B, 104C. Any number of user devices 104A, 104B, 104C may be included in a multicast group to which the base station 102 sends multicast data. The base station 102 and user devices 104A, 104B, 104C may also send control signals to each other, such as downlink maps and/or uplink maps.

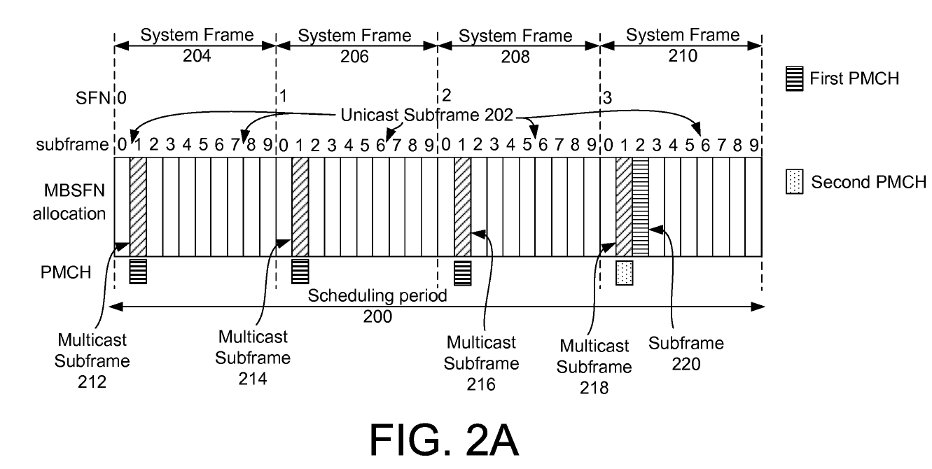

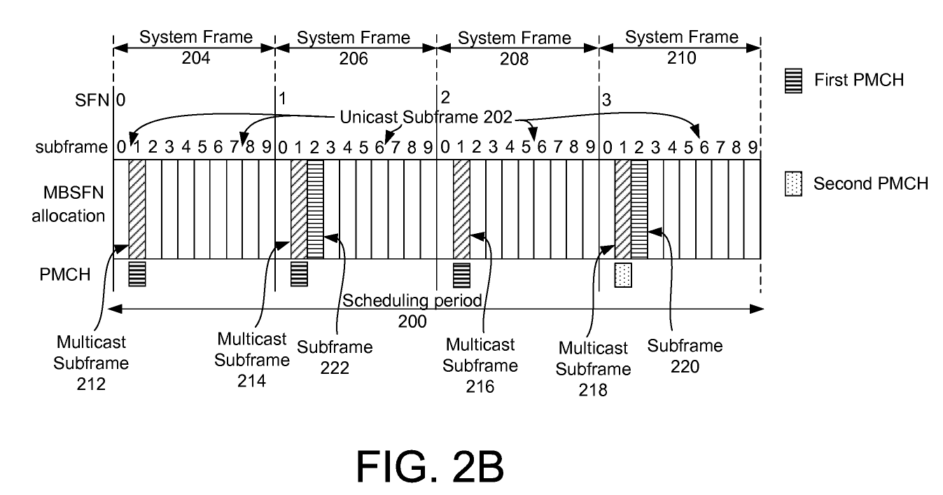

FIG. 2A is a diagram of a scheduling period 200 according to an example embodiment. The scheduling period 200 may be a time period over which the base station 102 (not shown in FIG. 2A) schedules multicast-service data on communication resources, such as time slots and/or subframes. The scheduling period 200 may repeat, with the same communication resources allocated in each scheduling period until the allocation of communication resources is changed, such as by the base station 102 sending an information element in system information broadcast, or on a multicast control channel (MCCH), informing terminals about re-allocating and/or rescheduling the communication resources. The UEs need to know what unicast subframes constitute the pool of (unicast) resources, which may possibly be used for multicast transmission, and the indication in the system information broadcast, or on a multicast control channel (MCCH) indicate the pool of (unicast) resources to the UEs. The subframe 220 constitutes the pool of (unicast) resources in the example. In the example shown in FIG. 2A, the scheduling period 200 is forty milliseconds (40 ms). However, scheduling periods may be other lengths of time, according to example embodiments.

In the example shown in FIG. 2A, the scheduling period 200 includes four system frames, system frame 0 204, system frame 1 206, system frame 2 208, and system frame 3 210. The system frames 204, 206, 208, 210 within the scheduling period 200 may each include multiple subframes. In the example shown in FIG. 2A, each system frame 204, 206, 208, 210 includes ten subframes, and each subframe is one millisecond (1 ms). The subframes may be considered subframes of communication resources, such as subframes of the dedicated multicast communication resource or subframes of the other communication resource. System frames may include different numbers of subframes than ten, and/or the subframes may have different time periods, according to example embodiments. The system frames 204, 206, 208, 210 may each have a same pattern or map of multicast subframes and unicast subframes. In the example shown in FIG. 2A, a “zero'th” (0^{th}) subframe and second through ninth (2-9) subframes in each system frame 204, 206, 208, 210 are unicast subframes 202 not dedicated to multicast transmission, and first (1) subframes 212, 214, 216, 218 in each system frame 204, 206, 208, 210 are dedicated to specific PMCHs. In the example shown in FIG. 2A, the multicast subframes 212, 214, 216 in the system frames 204, 206, 208 are dedicated to a specific PMCH such as a first PMCH, whereas the multicast subframe 218 in system frame 210 is dedicated to another PMCH, such as a second PMCH.

The base station 102 and/or MCE may assign and/or allocate one or more subframes for on-demand transmission. If the base station 102 determines that data to be multicast during the scheduling period 200 exceeds a dedicated multicast communication resource, such as the multicast subframes 212, 214, 216 assigned and/or dedicated to the first PMCH, then the base station 102 may borrow, on-demand, other communication resources such as the on-demand subframe 220 and/or multicast subframe 218 dedicated to the other channel, for multicasting the data. The base station 102 may multicast the data via the multicast subframes 212, 214, 216 and the borrowed other communication resource(s), such as the multicast subframe 218 dedicated to the second PMCH and/or the one or more subframes assigned and/or allocated for on-demand transmission. The base station 102 may assign and/or allocate, for on-demand transmission which may be used to satisfy multicast data requirements, a subframe 220 that would otherwise be assigned and/or allocated for unicast transmission. The base station 102 signals in each scheduling period what data are broadcast/multicast on what subframes of the dedicated communication resource(s) and the other communication resource(s) during the scheduling period using a MCH scheduling information element, as will be later explained in detail with reference to FIGS. 4A and 4B.

When transmitting the multicast data to the user devices 104A, 104B, 104C (not shown in FIG. 2A), the base station 102 may include an indication that multicast data are included in the other communication resource, such as the multicast subframe 218 dedicated to the second PMCH and/or the on-demand subframe, in either the dedicated multicast communication resource or the other communication resource. If the base station 102 includes the indication in the dedicated multicast communication resource, then the indication may be included in any of the multicast subframes 212, 214, 216 dedicated to the first PMCH. If the base station 102 includes the indication in the other communication resource, then the indication may be included in either the multicast subframe 218 dedicated to the second PMCH or the on-demand subframe 220. The base station 102 may transmit the indication on a subframe that precedes any of the subframes 220 of the other communication resource in the scheduling period 200.

The user devices 104A, 104B, 104C may process or ignore data in the on-demand subframe 220 based on the indication. If the indication indicates that the on-demand subframe 220 includes multicast data for a multicast service received by the respective user device 104A, 104B, 104C, then the respective user device 104A, 104B, 104C may process the data included in the on-demand subframe 220. Otherwise, if the on-demand subframe is normally scheduled to transmit unicast data to the user device 104A, 104B, 104C, then the user device 104A, 104B, 104C may process the data included in the on-demand subframe 220. If the on-demand subframe includes unicast data, and the on-demand subframe is not normally scheduled to transmit unicast data to the user device 104A, 104B, 104C, then the user device 104A, 104B, 104C may not process, and/or may ignore, the data included in the on-demand subframe 220.

While the other communication resource (in addition to the dedicated multicast communication resources including the multicast subframes 212, 214, 216) includes a single subframe 220 in the example shown in FIG. 2A, the other communication resource via which the data is multicast may include any number of subframes. The subframes included in the other communication resource may, for example, be interleaved with the subframes of the dedicated multicast communication resource in a PMCH scheduling period.

FIG. 2B is another diagram of the scheduling period 200 according to an example embodiment. In this example, multiple subframes 220, 222 included in the other communication resource are included in multiple system frames 206, 210 and interleaved with the subframes 212, 214, 216, 218 of the dedicated multicast communication resource in the scheduling period 200. The subframes 220, 222 may include on-demand subframes and/or unicast subframes scheduled by the base station 102.

The base station 102 may indicate that data will be multicast within the subframes 220, 222 interleaved with the multicast subframes 212, 214, 216, 218 of the dedicated multicast communication resource. The base station 102 may transmit the indication on a subframe of the dedicated multicast communication resource that precedes any of the subframes 220, 222 of the other communication resource in the scheduling period 200.

While the base station 102 may allocate on-demand subframes that the base station 102 may use to transmit multicast data to the user devices 104A, 104B, 104C, the base station 102 need not transmit multicast data via the on-demand subframes. The base station 102 may transmit unicast data to one of the user devices 104A, 104B, 104C via an on-demand subframe, or may not transmit any data via the on-demand subframe, according to example embodiments.

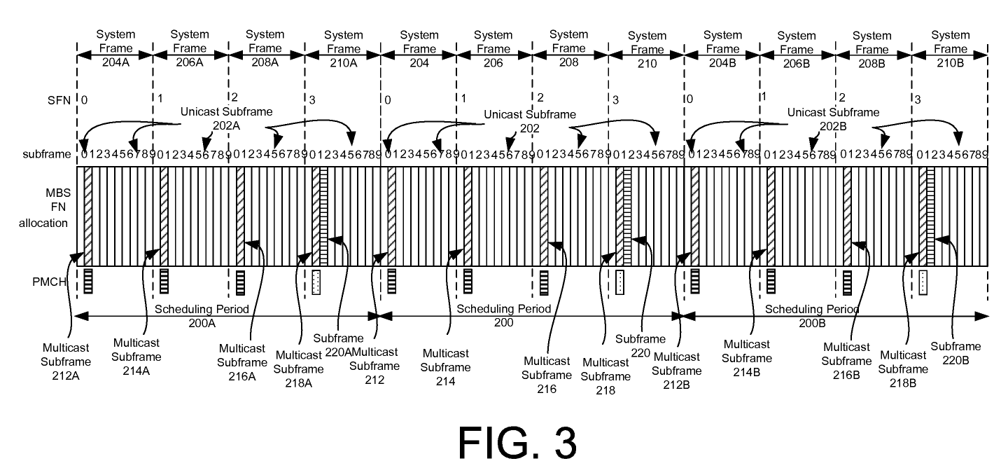

FIG. 3 is a diagram showing three scheduling periods 200A, 200, 200B according to an example embodiment. In this example, the data to be multicast by the base station 102 to the user devices 104A, 104B, 104C during the scheduling period 200 may exceed the dedicated multicast communication resources such as the multicast subframes 212, 214, 216, 218, and the base station 102 may multicast the data to the user devices 104A, 104B, 104C via the dedicated multicast communication resources and the other communication resource such as the on-demand subframe 220 described above.

However, in the scheduling period 200A immediately preceding the scheduling period 200 and/or the scheduling period 200B immediately after the scheduling period 200, the data to be multicast by the base station 102 to the user devices 104A, 104B, 104C may not exceed the dedicated multicast resources. Based on the data to be multicast in the scheduling period 200A immediately preceding the scheduling period 200 and/or the scheduling period 200B immediately after the scheduling period 200 not exceeding the dedicated multicast resources, the base station 102 may transmit the multicast data to the user devices 104A, 104B, 104C via only the dedicated multicast communication resources such as the multicast subframes 212A, 214A, 216A, 218A, 212B, 214B, 216B, 218B, and may either transmit unicast data or no data via the on-demand subframes 220A, 220B. In either or both of the scheduling periods 200A, 200B, data may be unicasted to a single user device 104A, 104B, 104C via at least one communication resource not dedicated to multicast, such as the on-demand subframe 220A, 220B or an assigned unicast subframe 202A, 202B, before and/or after multicasting the data via a communication resource not dedicated to multicast such as the on-demand subframe 220, without indicating that the data will be unicast.

FIG. 4A is a diagram of the scheduling information element according to an example embodiment. The scheduling information element may be MAC control element (CE) in MAC protocol data unit (PDU) included, e.g. in a first multicast subframe 212 of the scheduling period 200. The presence of the MAC CE in the first multicast subframe 212 of the scheduling period may indicate to the user devices 104A, 104B, 104C that the base station 102 will transmit multicast data via one or more of the on-demand subframes 220, 222; a lack of, or non-presence of, the MAC CE, may indicate to the user devices 104A, 104B, 104C that the base station 102 will transmit unicast data or no data via the on-demand subframe 220. In the example table below, the value ‘11101’ for the LCID in the header of MAC PDU may indicate the presence of the MAC CE:

| Index | LCID values |
|---|---|
| 00000 | MCCH (see note) |
| 00001-11100 | MTCH |
| 11101 | MCH Scheduling Information 2 |
| 11110 | MCH Scheduling Information |
| 11111 | Padding |

NOTE:
If there is no MCCH on MCH, an MTCH could use this value.

The top row shows bit numbers 400 of bits in the scheduling information element. For each multicast channel (MCH), of which FIG. 4A shows MCH 1, MCH 2, through MCH n, the scheduling information element may include spare bits 402, 420, and 438, an MCH field 404, 422, 440 which is the ordinal number of the MCH in the multimedia broadcast multicast service single frequency network (MBSFN) area as received on a multicast control channel (MCCH), an indicator 406A, 406B, 424A, 424B, 442A, 442B of the start of the borrowed subframes within the scheduling period 200, a logical channel identifier (LCID) 408, 412, 416, 426, 430, 434, 444, 448, 452 for LCID 1, LCID 2, through LCID 1, and an indicator 410A, 410B, 414A, 414B, 418A, 418B, 428A, 428B, 432A, 432B, 436A, 436B, 446A, 446B, 450A, 450B, 454A, 454B of where within the scheduling period 200 the multicast traffic channel (MTCH) identified by the respective LCID stops.

FIG. 4B is a diagram of another scheduling information element according to an example embodiment. The scheduling information element shown in FIG. 4B may include the fields shown and described above with respect to FIG. 4A. The scheduling information element shown in FIG. 4B may also include a length field 480, 482, 484 for each of the n multicast channels (MCHs). The length fields 480, 482, 484 may indicate a length of the scheduling information included for the particular MCH. In other words, the length field indicates for each MCH, how many LCID—StopMTCH pairs follow for that MCH. Depending on a scenario, it may be efficient to introduce the length indicator to avoid listing all MTCH multiplexed on MCH.

In one embodiment, both other communication resources are used, i.e. the base station may allocate multicast data to be transmitted in the unicast subframes of the pool of resources and in the unused subframes of one or more other PMCH(s) at the same time by using one MAC CE. As one example, the spare bit(s) of the MCH Scheduling Information structure may be used for indicating whether a given sequence of LCID—StopMTCH pairs within the structure addresses subframes of another PMCH or unicast subframes. As a nonlimiting example, the spare bit “1” may indicate that the MTCH corresponding to the spare bit is transmitted on the pool of (unicast) subframes, whereas a spare bit “0” may denote that the MTCH corresponding to the spare bit is be transmitted the other PMCH having unused resources during the scheduling period.

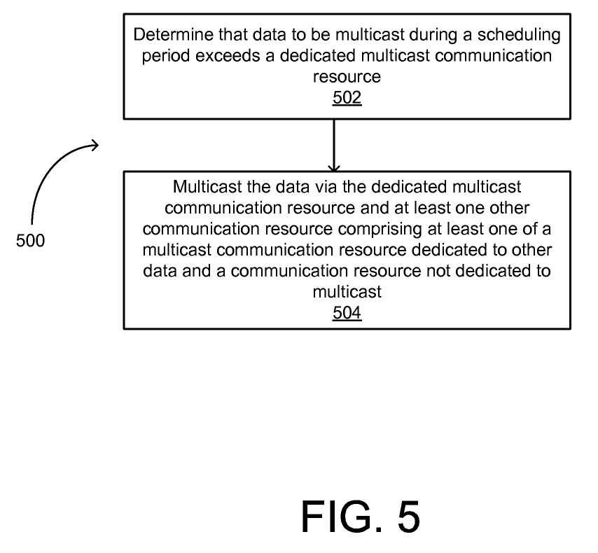

FIG. 5 shows a method 500 performed by the base station 102 according to an example embodiment. According to this example, the method 500 may include determining, by a base station, that data to be multicast during a scheduling period exceeds a dedicated multicast communication resource (502). The method 500 may also include multicasting the data via the dedicated multicast communication resource and at least one other communication resource comprising at least one of a multicast communication resource dedicated to other data and a communication resource not dedicated to multicast (504).

In an example embodiment, the dedicated multicast communication resource may include at least one subframe, and the other communication resource includes at least one subframe.

In an example embodiment, the dedicated multicast communication resource may include an indication that multicast data are included in at least one subframe of the other communication resource.

In an example embodiment, the subframes of other communication resource may be subsequent to the subframes of the dedicated multicast communication resource in the scheduling period.

In an example embodiment, the subframes of other communication resource may be interleaved with the subframes of the dedicated multicast communication resource in the scheduling period.

In an example embodiment, the method 500 may further include temporarily borrowing, on-demand, at least one subframe from a pool of subframes at least partly constituting the other communication resource, and applying the borrowed subframe for the transmission of the multicast data.

In an example embodiment, the method 500 may further include transmitting an indication of the allocated pool of subframes, wherein the indication is included in system information broadcast in a communication resource not dedicated to multicast.

In an example embodiment, the method 500 may further include transmitting an indication of the allocated pool of subframes, wherein the indication is provided on multicast control channel (MCCH) of the dedicated multicast communication resource.

In one embodiment, the MCE may configure such pool of subframes (which is comprised in the other communication resources) without even knowing whether or not a lack of multicast resources will take place. In one embodiment, the MCE may indicate the pool of subframes to eNBs, which in turn signal it to the UEs (e.g. in the system information broadcast and/or in the multicast control channel). In one embodiment, the MCE is part of an eNB. In another embodiment, the MCE and the eNB are separated by an open M2 interface.

In an example embodiment, the dedicated multicast communication resource includes a specific physical multicast channel (PMCH); and the method 500 may further comprise detecting that the specific PMCH has insufficient multicast communication resources for multicasting the data in a scheduling period, and applying multicast communication resources of another PMCH for multicasting the data of the specific PMCH.

In an example embodiment, the dedicated multicast communication resource may include a specific physical multicast channel (PMCH), and the multicasting includes multicasting the data for multicast transmission via the specific PMCH, another PMCH, and a subframe not used to carry a PMCH.

In an example embodiment, the base station may include a Long-Term Evolution (LTE) E-UTRAN NodeB (eNodeB).

In an example embodiment, the data for multicast transmission may include push-to-talk data.

In an example embodiment, the dedicated multicast communication resource may include at least one subframe carrying an indication that some data for multicast transmission will be included in the at least one other communication resource, and the subframe carrying the indication shall precede any subframe of the other communication resource in the scheduling period.

In an example embodiment, the method 500 may further include multicasting an indication within a logical channel identification (LCID) field that some of the data for multicast transmission will be included in the at least one other communication resource.

In an example embodiment, the LCID field may be included in a multicast channel (MCH) medium access control (MAC) header and indicates existence of a scheduling information control element in the same MAC PDU.

In an example embodiment, the method 500 may further include unicasting data to a single user device via at least one communication resource not dedicated to multicast, after multicasting the data via communication resource not dedicated to multicast, without indicating that the data will be unicast.

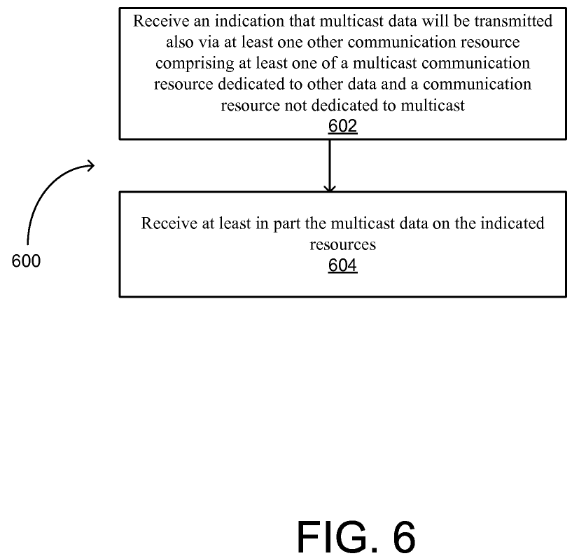

FIG. 6 shows a method 600 performed by a user device 104A, 104B, 104C according to an example embodiment. The method 600 may include receiving, by a user device, an indication that multicast data will be transmitted also via at least one other communication resource comprising at least one of a multicast communication resource dedicated to other data and a communication resource not dedicated to multicast (602). The method 600 may also include receiving at least in part the multicast data on the indicated resources (604).

In an example embodiment, the dedicated multicast communication resource may include a specific physical multicast channel (PMCH), and the specific PMCH may include the indication.

In an example embodiment, the other communication resource may include multicast communication resources of another PMCH.

In an example embodiment, the method 600 may further include receiving, by a user device, an indication of an allocated pool of subframes at least partly constituting the other communication resource, and temporarily receiving, on-demand, at least one subframe from the pool of subframes at least partly constituting the other communication resource.

In an example embodiment, the indication may be included in system information broadcast in a communication resource not dedicated to multicast.

In an example embodiment, the indication may be provided on a multicast control channel (MCCH) of the dedicated multicast communication resource.

In an example embodiment, the multicast-service may be push-to-talk.

In one embodiment, a UE receiving both MBMS and unicast may expect to receive unicast transmissions only in those unicast subframes of the allocated pool of subframes where the received scheduling information does not indicate MBMS allocation.

When on-demand MBMS transmission occurs and unicast subframes are borrowed for MBMS transmission from the pool of (unicast) subframes, it may be that only UEs receiving the PMCH are informed about the event. Other UEs may expect the unicast subframe and operates accordingly. This may cause problems in measurements when legacy UEs perform measurements in the borrowed frames. However, as said earlier, the information about on-demand MBMS subframes may be provided in system information messages and/or on MCCH. In this way, the UEs which understand the new information may avoid performing measurements in the on-demand MBMS subframes or they may account for the possibility that the subframe is used for MBMS transmission.

In one embodiment, the newly allocated on-demand MBMS frames are linked to only one PMCH configured in the MBSFN area. The MCE may provision the relation information together with other configuration information over M2 interface. Alternatively, the on-demand MBMS frames are always linked to the first PMCH in the list of PMCHs configured for the MBMSF area.

In another embodiment, the on-demand MBMS frames are shared among multiple PMCHs. In this case, there may be a case where the eNB receives more data than the eNB can transmit for more than one PMCH. In such case, the eNB may use the on-demand MBMS frames for the transmission of data associated with the higher priority PMCH. The PMCHs may be assigned priorities either implicitly, i.e. based on the order in which PMCH are transmitted, or explicitly using M2 signalling between the MCE and the eNB.

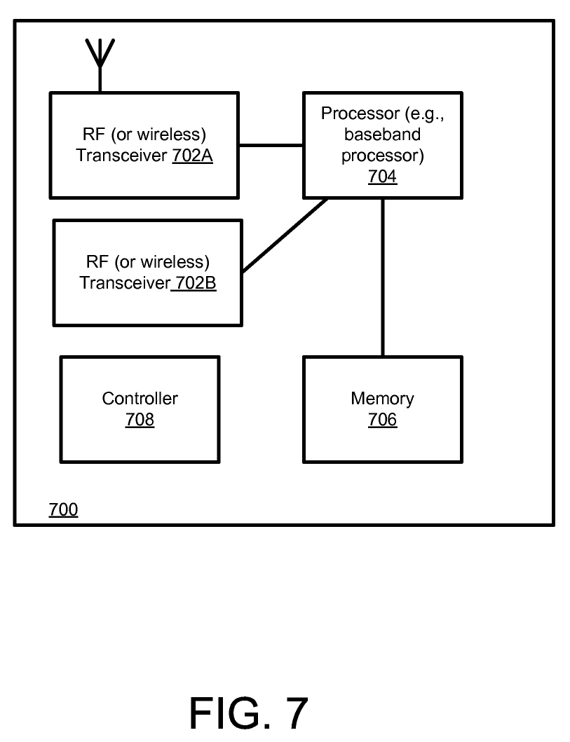

FIG. 7 is a block diagram of a wireless station (e.g., base station or user device) 700 according to an example implementation. The wireless station 700 may include, for example, two RF (radio frequency) or wireless transceivers 702A, 702B, where each wireless transceiver includes a transmitter to transmit signals and a receiver to receive signals. The wireless station 700 also includes a processor or control unit/entity (controller) 704 to execute instructions or software and control transmission and receptions of signals, and a memory 706 to store data and/or instructions.

Processor 704 may also make decisions or determinations, generate frames, packets or messages for transmission, decode received frames or messages for further processing, and other tasks or functions described herein. Processor 704, which may be a baseband processor, for example, may generate messages, packets, frames or other signals for transmission via wireless transceiver 702 (702A or 702B). Processor 704 may control transmission of signals or messages over a wireless network, and may control the reception of signals or messages, etc., via a wireless network (e.g., after being down-converted by wireless transceiver 702, for example). Processor 704 may be programmable and capable of executing software or other instructions stored in memory or on other computer media to perform the various tasks and functions described above, such as one or more of the tasks or methods described above. Processor 704 may be (or may include), for example, hardware, programmable logic, a programmable processor that executes software or firmware, and/or any combination of these. Using other terminology, processor 704 and transceiver 702 together may be considered as a wireless transmitter/receiver system, for example.

In addition, referring to FIG. 7, a controller (or processor) 708 may execute software and instructions, and may provide overall control for the station 700, and may provide control for other systems not shown in FIG. 7, such as controlling input/output devices (e.g., display, keypad), and/or may execute software for one or more applications that may be provided on wireless station 700, such as, for example, an email program, audio/video applications, a word processor, a Voice over IP application, or other application or software.

In addition, a storage medium may be provided that includes stored instructions, which when executed by a controller or processor may result in the processor 704, or other controller or processor, performing one or more of the functions or tasks described above.

According to another example implementation, RF or wireless transceiver(s) 702A/702B may receive signals or data and/or transmit or send signals or data. Processor 704 (and possibly transceivers 702A/702B) may control the RF or wireless transceiver 702A or 702B to receive, send, broadcast or transmit signals or data.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1.-30. (canceled)

31. An apparatus, comprising:
at least one processor and at least one memory including a computer program code, wherein the at least one memory and the computer program code are configured, with the at least one processor, to cause the apparatus to:
determine that data to be multicast during a scheduling period exceeds a dedicated multicast communication resource; and
multicast the data via the dedicated multicast communication resource and at least one other communication resource comprising at least one of a multicast communication resource dedicated to other data and a communication resource not dedicated to multicast.

32. The apparatus of claim 31, wherein the dedicated multicast communication resource includes an indication that multicast data are included in at least one subframe of the other communication resource.

33. The apparatus of claim 32, wherein the at least one memory and the computer program code are configured, with the at least one processor, to cause the apparatus to:
multicast the indication within a logical channel identification (LCID) field that some of the data for multicast transmission will be included in the at least one other communication resource.

34. The apparatus of claim 33, wherein the LCID field is included in a multicast channel, MCH, medium access control, MAC, header and indicates an existence of a scheduling information control element in the same MAC protocol data unit, PDU.

35. The apparatus of claim 31, wherein:
subframes of the at least one other communication resource are subsequent to subframes of the dedicated multicast communication resource in the scheduling period.

36. The apparatus of claim 31, wherein:
subframes of the at least one other communication resource are interleaved with subframes of the dedicated multicast communication resource in the scheduling period.

37. The apparatus of claim 31, wherein the at least one memory and the computer program code are configured, with the at least one processor, to cause the apparatus to:
temporarily borrow, on-demand, at least one subframe from a pool of subframes at least partly constituting the other communication resource; and
apply the borrowed subframe for the transmission of the multicast data.

38. The apparatus of claim 37, wherein the at least one memory and the computer program code are configured, with the at least one processor, to cause the apparatus to:
transmit an indication of the pool of subframes, wherein the indication is included in system information broadcast in a communication resource not dedicated to multicast.

39. The apparatus of claim 37, further comprising:
transmit an indication of the pool of subframes, wherein the indication is provided on multicast control channel (MCCH) of the dedicated multicast communication resource.

40. The apparatus of claim 31, wherein the dedicated multicast communication resource includes a specific physical multicast channel (PMCH); and
wherein the at least one memory and the computer program code are configured, with the at least one processor, to cause the apparatus to:
detect that the specific PMCH has insufficient multicast communication resources for multicasting the data in a scheduling period; and
apply multicast communication resources of another PMCH for multicasting the data of the specific PMCH.

41. The apparatus of claim 31, wherein:
the dedicated multicast communication resource includes a specific physical multicast channel (PMCH); and
the multicasting includes multicasting the data for multicast transmission via the specific PMCH, another PMCH, and a subframe not dedicated to a PMCH.

42. The apparatus of claim 31, wherein the at least one memory and the computer program code are configured, with the at least one processor, to cause the apparatus to:
unicast data to a single user device via at least one communication resource not dedicated to multicast, after multicasting the data via communication resource not dedicated to multicast, without indicating that the data will be unicast.

43. The apparatus of claim 31, wherein the apparatus is or is comprised in a base station.

44. An apparatus comprising:
at least one processor and at least one memory including a computer program code, wherein the at least one memory and the computer program code are configured, with the at least one processor, to cause the apparatus to:
receive an indication that multicast data will be transmitted also via at least one other communication resource comprising at least one of a multicast communication resource dedicated to other data and a communication resource not dedicated to multicast; and
receive at least part of the multicast data on the indicated resources.

45. The apparatus of claim 44, wherein:
the dedicated multicast communication resource includes a specific physical multicast channel (PMCH); and
the specific PMCH includes the indication.

46. The apparatus of claim 44, wherein the other communication resource comprises multicast communication resources of another PMCH.

47. The apparatus of claim 44, wherein the at least one memory and the computer program code are configured, with the at least one processor, to cause the apparatus to:
receive an indication of an allocated pool of subframes at least partly constituting the other communication resource; and
receiving the multicast data on at least one subframe from the pool of subframes constituting the other communication resource.

48. The apparatus of claim 47, wherein the indication is received in one of: system information broadcast in a communication resource not dedicated to multicast, and a multicast control channel (MCCH) of the dedicated multicast communication resource.

49. The apparatus of claim 44, wherein the apparatus is or is comprised in a user equipment.

50. A method comprising:
receiving, by a user device, an indication that multicast data will be transmitted also via at least one other communication resource comprising at least one of a multicast communication resource dedicated to other data and a communication resource not dedicated to multicast; and
receiving at least part of the multicast data on the indicated resources.
